(19) United States
(12) Patent Application Publication
(10) Pub. No.: US 2014/0244561 A1
(43) Pub. Date: Aug. 28, 2014

(54) PROVIDING RECOMMENDATIONS TO MEMBERS OF A SOCIAL NETWORK

(71) Applicant: LinkedIn Corporation, Mountain View, CA (US)

(72) Inventors: Heyning Cheng, Los Gatos, CA (US); Navneet Kapur, Sunnyvale, CA (US); Abhimanyu Lad, San Mateo, CA (US); Monica Rogati, Sunnyvale, CA (US)

(73) Assignee: LinkedIn Corporation, Mountain View, CA (US)

(21) Appl. No.: 13/780,116

(22) Filed: Feb. 28, 2013

(51) Int. Cl. G06N 5/02

(52) U.S. Cl. CPC G06N 5/02
USPC 706/46

(57) ABSTRACT

Systems and methods for providing career recommendations to a member of a social network are described. In some example embodiments, the systems and methods receive input associated with a professional or aspirational goal from a member of a social network, determine a recommendation based on information stored by the social network, and provide the recommendation to the member of the social network, among other things.

### TECHNICAL FIELD

The present disclosure generally relates to providing job application services via websites. More specifically, the present disclosure relates to methods, systems and computer program products for using social network information to provide recommendations to members of the social network.

### BACKGROUND

Online social network services provide users with a mechanism for defining, and memorializing in a digital format, their relationships with other people. This digital representation of real-world relationships is frequently referred to as a social graph. Many social network services utilize a social graph to facilitate electronic communications and the sharing of information between its users or members. For instance, the relationship between two members of a social network service, as defined in the social graph of the social network service, may determine the access and sharing privileges that exist between the two members. As such, the social graph in use by a social network service may determine the manner in which two members of the social network service can interact with one another via the various communication and sharing mechanisms supported by the social network service.

Some social network services aim to enable friends and family to communicate and share with one another, while others are specifically directed to business users with a goal of facilitating the establishment of professional networks and the sharing of business information. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

With many social network services, members are prompted to provide a variety of personal information, which may be displayed in a member's personal web page. Such information is commonly referred to as “personal profile information”, or simply “profile information”, and when shown collectively, it is commonly referred to as a member's profile. For example, with some of the many social network services in use today, the personal information that is commonly requested and displayed as part of a member's profile includes a member's age (e.g., birth date), gender, contact information, home town, address, the name of the member's spouse and/or family members, a photograph of the member, interests, and so forth. With certain social network services, such as some business network services, a member's personal information may include information commonly included in a professional resume or curriculum vitae, such as information about a person's education, employment history, job skills, professional organizations, and so forth. With some social network services, a member's profile may be viewable to the public by default, or alternatively, the member may specify that only some portion of the profile is to be public by default. As such, many social network services serve as a sort of directory of people to be searched and browsed.

### DESCRIPTION OF THE DRAWINGS

Some embodiments of the technology are illustrated by way of example and not limitation in the figures of the accompanying drawings.

FIG. 1 is a block diagram illustrating various functional components of a suitable computing environment, consistent with some embodiments, for providing recommendations to members of a social network.

FIG. 2 is a block diagram illustrating modules of a career recommendation engine, consistent with some embodiments.

FIG. 3 is schematic diagram illustrating an example comparison of attributes between members of a social network, consistent with some embodiments.

FIG. 4 is a flow diagram illustrating an example method for providing a career recommendation to a member of a social network, consistent with some embodiments.

FIG. 5 is a flow diagram illustrating an example method for providing a career recommendation to a member of a social network based on a comparison of attributes with another member of the social network, consistent with some embodiments.

FIGS. 6A and 6B are display diagrams illustrating recommendations presented to a member of a social network, consistent with some embodiments.

FIG. 7 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for providing recommendations, such as career, aspirational, or professional recommendations, to members of a social network.

The systems and methods described herein may receive input associated with a professional or aspirational goal from a member of a social network, determine a recommendation based on information stored by the social network, and provide the recommendation to the member of the social network. For example, the systems and methods may determine the recommendation based on a comparison of attributes associated with the member of the social network to attributes associated with the professional goal, and/or based on a comparison of attributes associated with the member of the social network to attributes associated with another member of the social network that has achieved the professional goal, among other things.

For example, the systems and methods may receive input that identifies a job title from a member of a social network, identify other members within the social network that have the identified job title, compare attributes of the member to attributes of the other members within the social network that have the identified job title, determine at least one difference between the attributes of the member and the attributes of the identified other members, and provide a recommendation to the member of the social network based on the determined difference.

Therefore, in some example embodiments, the systems and methods may act as a data driven career advisor that receives goal information and provides recommendations based on data stored within a social network that may enable a member to reach or progress to the goal, among other benefits.

A social network service is a useful location from which to utilize various types of information associated with generating and/or determining recommendations for its members. Often, a social network or other similar site, such as LinkedIn, Facebook, Google+, Twitter, and so on, stores various types of information associated with members of the site. For example, a friend-based social networking service may store interest information for a member (e.g., information about things a member “likes”), whereas a business-based social networking service may store accomplishment or experience information for a member (e.g., educational or work experience information). Additionally, a social networking service may store a variety of information associated with a member's social graph, such as information identifying other members within the member's social graph, and so on.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

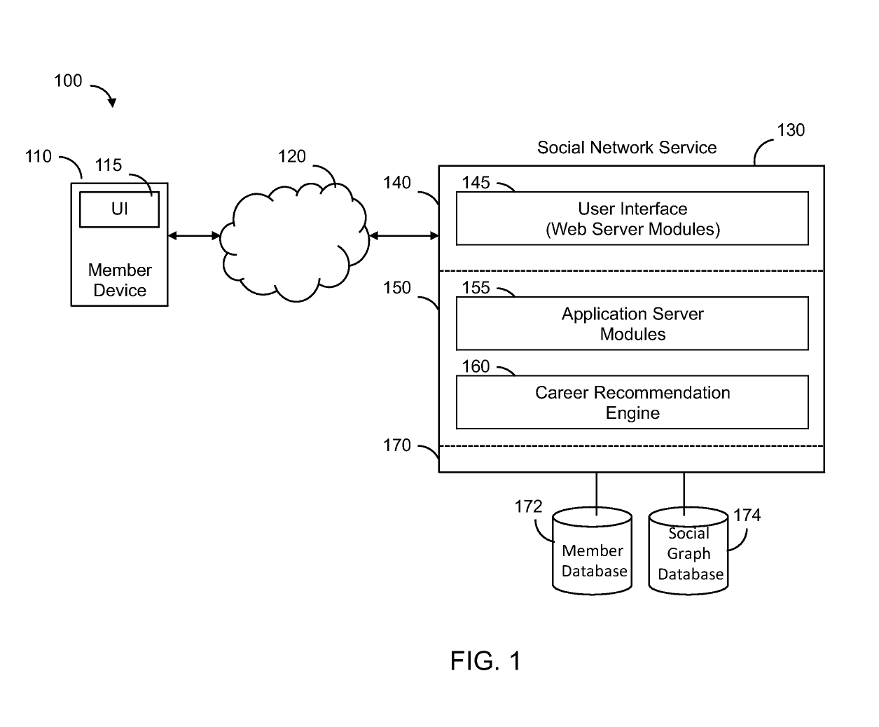

FIG. 1 is a block diagram illustrating various functional components of a suitable computing environment 100, consistent with some embodiments, for providing recommendations to members of a social network.

As shown in FIG. 1, the computing environment 100 includes a social network service 130 that is generally based on a three-tiered architecture, consisting of a front-end layer 140, an application logic layer 150, and a data layer 170. The modules, systems, and/or engines shown in FIG. 1 represent a set of executable software instructions and the corresponding hardware (e.g., memory and processor) for executing the instructions. However, one skilled in the art will readily recognize that various additional functional modules and engines may be used with the social network service 130 to facilitate additional functionality that is not specifically described herein. Furthermore, the various functional modules and engines depicted in FIG. 1 may reside on a single server computer, or may be distributed across several server computers in various arrangements.

As shown in FIG. 1, the front end layer 140 includes a user interface module (e.g., a web server) 145, which receives requests from various client-computing devices, such as member device 110, over a network 120, and communicates appropriate responses to the requesting client devices. For example, the user interface module(s) 140 may receive requests in the form of Hypertext Transport Protocol (HTTP) requests, or other web-based, application programming interface (API) requests. The client devices 110 may be executing conventional web browser applications, or applications that have been developed for a specific platform to include any of a wide variety of mobile devices and operating systems.

The network 120 may be any communications network utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, wireless data networks (e.g., Wi-Fi® and WiMax® networks), and so on.

As shown in FIG. 1, the data layer 170 includes several databases, including databases for storing data for various entities of the social graph, such as a member database 172 of member profile information, and a social graph database 174, which may include a particular type of database that uses graph structures with nodes, edges, and properties to represent and store data, such as social graph information. Of course, in some example embodiments, any number of other entities might be included in the social graph, and as such, various other databases may be used to store data corresponding with other entities.

In some example embodiments, when a person initially registers to become a member of the social network service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored, for example, as member profile information or data in database 172.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity, which may or may not be included in the social graph.

The social network service 130 may provide a broad range of other applications and services that allow members the opportunity to share and receive information, often customized to the interests of the member. For example, in some example embodiments, the social network service 130 may include a photo sharing application that allows members to upload and share photos with other members. As such, a photograph may be a property or entity included within a social graph.

In some example embodiments, members of a social network service 130 may be able to self-organize into groups, or interest groups, organized around a subject matter or topic of interest. When a member joins a group, his or her membership in the group may be reflected in the social graph information stored in the social graph database 174. In some example embodiments, members may subscribe to or join groups affiliated with one or more companies. Thus, membership in a group, a subscription or following relationship with a company or group, as well as an employment relationship with a company, may all be examples of the different types of relationships that may exist between different entities, as defined by the social graph and modelled with the social graph information of the social graph database 174.

The application logic layer 150 includes various application server modules 155, which, in conjunction with the user interface module(s) 145, generates various user interfaces (e.g., web pages) with data retrieved from various data sources in the data layer 170. In some example some embodiments, individual application server modules 155 are used to implement the functionality associated with various applications, services and features of the social network service 130. For example, a messaging application, such as an email application, an instant messaging application, or some hybrid or variation of the two, may be implemented with one or more application server modules 155. Similarly, a search engine enabling users to search for and browse member profiles may be implemented with one or more application server modules 155. Of course, other applications or services that utilize a career recommendation engine 160 may be separately embodied in their own application server modules 155.

In addition to the various application server modules 155, the application logic layer 150 includes the career recommendation engine 160. The career recommendation engine 160 may perform one or more algorithmic processes that, in response to receiving input information associated with a goal (e.g., a job title, a name of an industry, a name of a company, and so on) generate, determine and/or return a recommendation associated with a task or action to be performed by a member of the social network, such as a recommendation identifying a degree to obtain, work experience to achieve, a career path to follow, and so on.

As illustrated in FIG. 1, in some example embodiments, the career recommendation engine 160 is implemented as a service that operates in conjunction with various application server modules 155. For instance, any number of individual application server modules 155 may invoke the functionality of the career recommendation engine 160, to include an application server module associated with receiving information from the member device 110 and/or an application server module associated with an application to facilitate the viewing of member profiles. However, in some example embodiments, the career recommendation engine 160 may be implemented as its own application server module such that it operates as a stand-alone application or system.

In some example embodiments, the career recommendation engine 160 may include or have an associated publicly available Application Programming Interface (API) that enables third-party applications or other applications, algorithms or scripts within the social network service 130 to invoke the functionality of the career recommendation engine 160, among other things.

### Examples for Providing Recommendations to Members of a Social Network

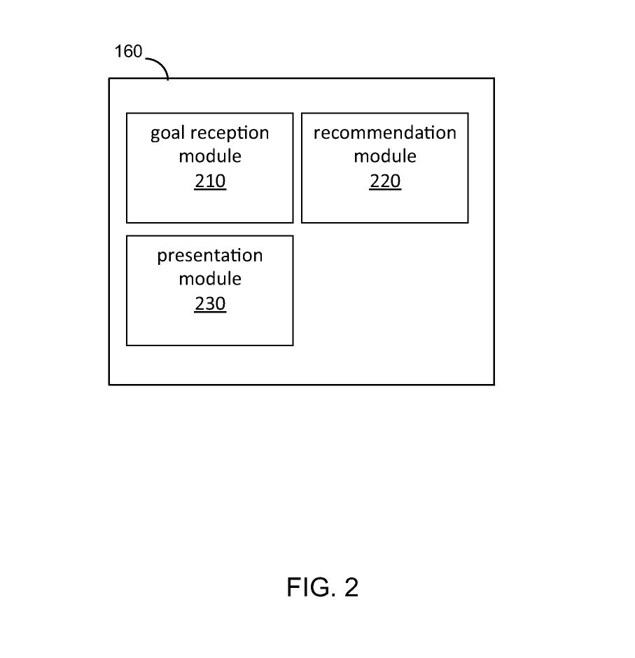

As described herein, in some example embodiments, the career recommendation engine 160 provides recommendations to members of a social network based on goal or aspiration input provided by the members. FIG. 2 is a block diagram illustrating modules of the career recommendation engine 160, consistent with some embodiments.

As illustrated in FIG. 2, the career recommendation engine 160 includes a variety of functional modules. One skilled in the art will appreciate that the functional modules are implemented with a combination of software (e.g., executable instructions, or computer code) and hardware (e.g., at least a memory and processor). Accordingly, as used herein, in some example embodiments a module is a processor-implemented module and represents a computing device having a processor that is at least temporarily configured and/or programmed by executable instructions stored in memory to perform one or more of the particular functions that are described herein.

Referring to FIG. 2, the career recommendation engine 160 includes a goal reception module 210, a recommendation module 220, a presentation module 230, and other modules not shown in the Figure.

In some example embodiments, the goal reception module 210 is configured and/or programmed to receive and/or access input or information associated with a professional goal or aspiration from a member of a social network. For example, the goal reception module 210 may receive input provided by a member at the user interface 115 of the member device 110 that is transmitted to one or more web server modules 145 of the social network service 130 via the network 120.

The received input may be any type of information that identifies a goal or aspiration to be provided to the career recommendation engine 160. Examples of information identifying a goal or aspiration includes information identifying a job title (e.g., “CEO” or “Publisher”), information identifying an occupation (e.g., “Actor”), information identifying desired job tasks (e.g., “write source code”), information identifying an industry (e.g., “computer software” or “education”), information identifying a company or organization (“Apple” or “the FBI”), information identifying a geographic location or region (e.g., “San Francisco Bay Area”), information identifying a university or degree (e.g., “Master's degree in Physics”), information identifying a life goal (“a Philanthropist”), combinations thereof, and so on.

In some example embodiments, the goal reception module 210 may receive input identifying a member of the social network as a goal or aspiration. That is, the goal reception module 210 may receive a selection of a target member of the social network to represent a goal or aspiration, because the member has attributes associated with the goal. For example, a target member who is a CTO at a company may be selected by a member with a goal of becoming a CTO. In some example embodiments, a given member may select a target member as a role model or aspiration by activating a user interface element displayed on the profile page of the target member on the social networking site. In this scenario, the goal reception module 210 may infer and/or determine a professional goal of the given member based on attributes of the target member's profile, such as the member's current job title and company.

In some example embodiments, the goal reception module 210 may receive input identifying a job opportunity advertised with the social network service as a goal or aspiration. The goal reception module 210 may receive a selection of a job posting to represent the goal or aspiration. For example, a job posting for a software engineer position at an internet company could be selected by a member who is currently a student and who aspires to work as a software engineer. The member may select the job opportunity as an aspiration by activating a user interface element displayed on a page containing the job posting displayed by the social network service.

In some example embodiments, the recommendation module 220 is configured and/or programmed to generate and/or determine a recommendation based on information stored by the social network, such as the received and/or accessed goal information. For example, the recommendation module 220 may identify member attribute information associated with a member that input the goal information, and determine a recommendation in response to the input goal information that is based on the member attribute information.

The recommendation module 220 may utilize various different algorithmic processes to determine recommendations in response to received goal information, including processes that compare attributes of a requesting member (i.e., the member that input the goal information) to attributes associated with the goal and/or processes that compare attributes of the requesting member to attributes of a target member or target group of members that are associated with the goal (i.e., have achieved the goal).

The output of the algorithmic processes, and therefore the recommendation module 220, may be one or more identified recommendations, such as tasks, career or professional experiences, education achievements, skills, degrees or certificates, and so on, which, when achieved and/or completed by a requesting member, may enable the member to achieve his or her goal, among other things. For example, the output may be a task (e.g., “get a certificate in SQL”), an education experience or benchmark (e.g., an MBA in Finance), a career experience (e.g., database programmer), a career path (e.g., “find an entry level job in publishing”), and/or an identification of another member associated with the goal, among other things.

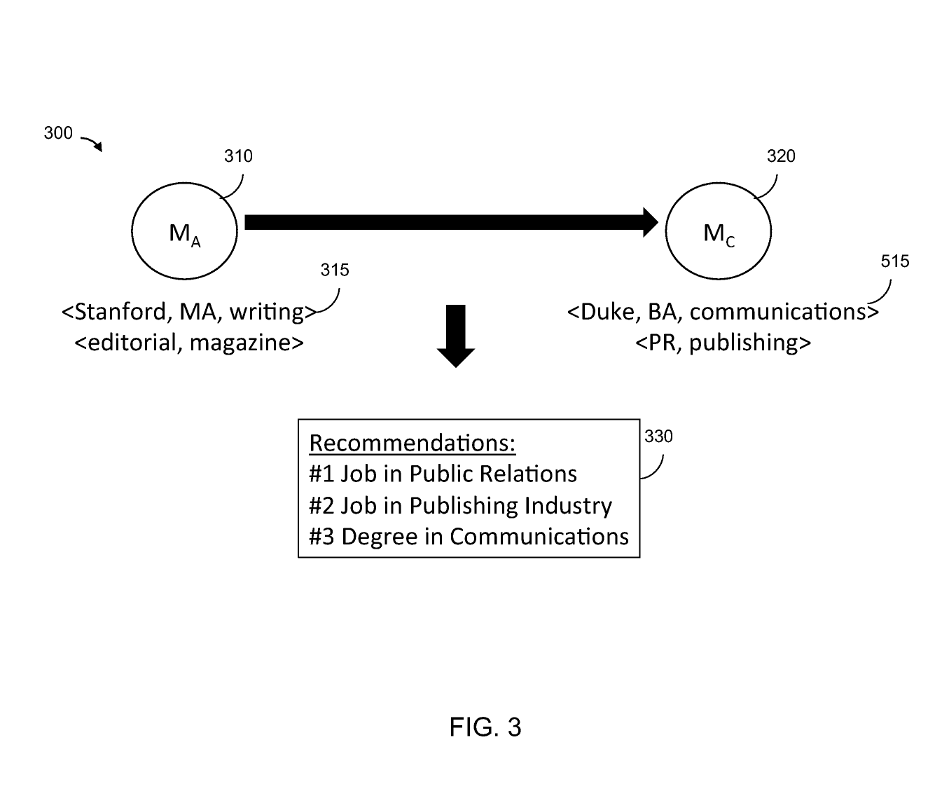

FIG. 3 is schematic diagram 300 illustrating an example comparison of attributes between members of a social network, consistent with some embodiments. The diagram 300 depicts a requesting member M_{A}, and a target member M_{C}. The requesting member M_{A} is associated with attributes (depicted as structured fields), such as education attributes=<Stanford, Mass., writing> and career attributes=<editorial, magazine>. The target member M_{C}, who represents an input goal or aspiration, is associated with attributes, such as education attributes=<Duke, BA, communications> and career attributes=<PR, publishing>.

Given the attributes of the requesting member M_{A} and the target member M_{C}, the recommendation module 220 may determine one or more recommendations 330 by comparing the attributes of the members and identifying the similarities and/or differences. For example, using the example depicted by FIG. 3, the recommendation module 220 may determine, based on the comparison of attributes, recommendations for the requesting member M_{A} that include obtaining a position in public relations, working in the publishing industry, and obtaining a degree in communications, among other recommendations.

Returning back to FIG. 2, in some example embodiments, the presentation module 230 is configured and/or programmed to present the recommendations to the member of the social network. For example, the presentation module 230 may display, via the user interface 115 of the member device 110, one or more recommendations that may assist the member in achieving an input goal or aspiration.

Thus, the presentation module 230 may present an indication of attributes associated with a professional goal and not associated with the member of the social network, an indication of attributes associated with another member of the social network that has achieved the professional goal and not associated with the member of the social network, an indication of attributes associated with a group of members of the social network that have achieved the professional goal and not associated with the member of the social network, and so on.

In some example embodiments, the presentation module 230 may present, along with recommendations, content that is sponsored and/or affiliated with an institution, organization, company, and so on. For example, the presentation module 230 may present sponsored content associated with a presented recommendation (e.g., an advertisement for a LSAT review course is presented along with a recommendation to go to law school), may present listing information associated with a recommendation (e.g., a link to job listings for software engineers associated with a recommendation to obtain a programming job), may present supplemental information along with a presented recommendation (e.g., a blog entry on switching careers along with a recommendation to switch a career path), and so on.

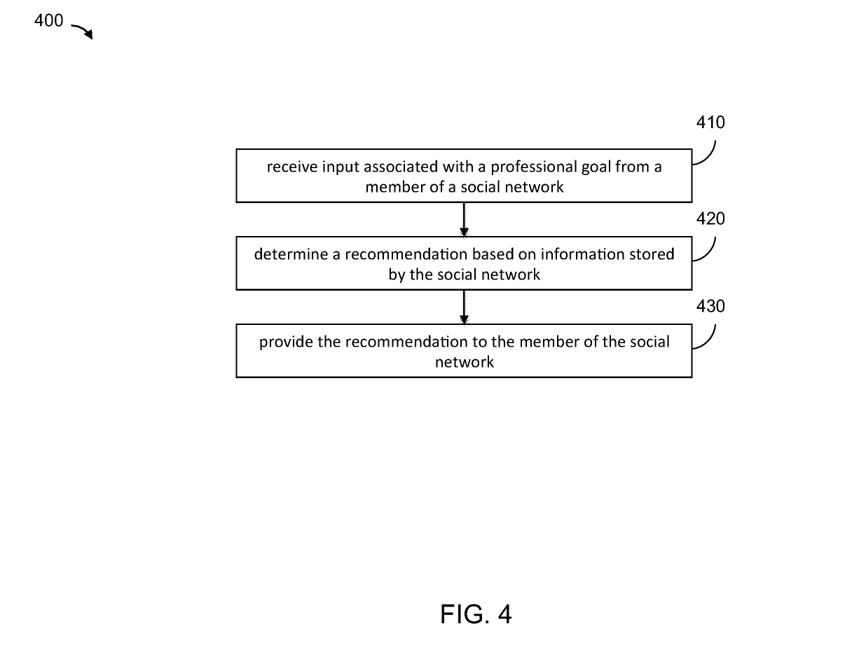

As described herein, the career recommendation engine 160 and/or the modules 210-230 may perform various methods in order to determine recommendations based on information received from a member that identifies a goal or aspiration of the member. FIG. 4 is a flow diagram illustrating an example method 400 for providing a career recommendation to a member of a social network, consistent with some embodiments.

In operation 410, the career recommendation engine 160 receives input associated with a professional goal from a member of a social network, such as a requesting member. For example, the goal reception module 210 receives input from a requesting member that identifies a goal or aspiration.

In operation 420, the career recommendation engine 160 determines a recommendation based on information stored by the social network. For example, the recommendation module 220 determines a recommendation based on information associated with other members of the social network having attributes associated with the received goal information.

For example, the recommendation module 220 may determine a recommendation based on attributes associated with a group of members of the social network that have successfully completed a transition from a first work profession associated with a current profession of the member to a second profession associated with the professional goal, based on information stored by the social network includes automatically identifying actions taken by other members of the social network that are statistically associated with achieving the professional goal input by the member of the social network, based on information stored by the social network includes automatically identifying attributes of other members of the social network that are statistically associated with achieving the professional goal input by the member of the social network, and so on.

In operation 430, the career recommendation engine 160 provides the recommendation to the member of the social network. For example, the presentation module 230 presents one or more recommendations to the requesting member via the user interface 115 of the member device 110.

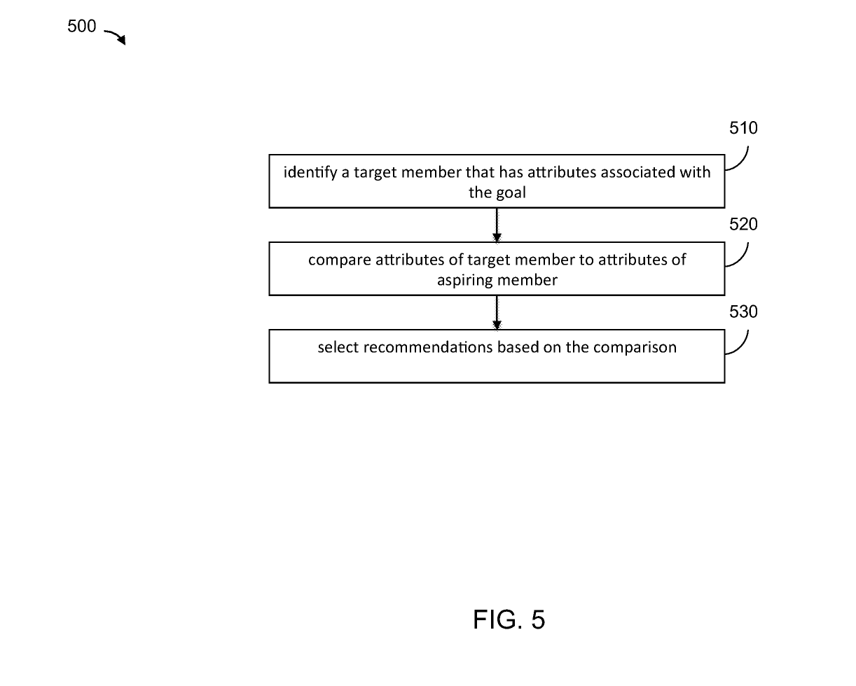

As described herein, in some example embodiments, the career recommendation engine 160 may determine one or more recommendations based on attributes associated with a goal, attributes associated with target members having achieved the goal, attributes associated with a group of target members having achieved the goal, and so on. FIG. 5 is a flow diagram illustrating an example method 500 for providing a career recommendation to a member of a social network based on a comparison of attributes with another member of the social network, consistent with some embodiments.

In operation 510, the career recommendation engine 160 identifies a target member of a social network that has an attribute associated with a received goal or aspiration. For example, the career recommendation engine 160 may identify attributes that members who have achieved the professional goal are likely to have (e.g., software engineers live in the Bay Area, financial professionals have MBAs, and so on).

In operation 520, the career recommendation engine 520 compares attributes associated with a requesting member of the social network to attributes associated with the target member of the social network, and, in, operation 530, determines a recommendation to present to the member of the social network based on the comparison of attributes. For example, the recommendation module 220 may perform some or all of the techniques described herein in order to determine a recommendation based on a comparison of attributes between a request member and one or more target members of a social network.

In some example embodiments, the career recommendation engine 160 may compute a metric or score that indicates the strength of the statistical relationship between taking the recommended action or having the recommended attribute and achieving the professional goal. For example, given a professional goal G and a recommendation R, the engine 160 may calculate a score as follows:

Score(G, R)=[M(G,R)/M(R)]/[M(G,˜R)/M(˜R)], where M(G,R) denotes the number of members with the recommended attribute R who have achieved goal G, M(R) denotes the number of members with the recommended attribute R, M(G,˜R) denotes the number of members without the recommended attribute R who have achieved goal G, and M(˜R) denotes the number of members without the recommended attribute R.

In some example embodiments, the score assigned to a recommendation may also be determined based on the number of members with the recommended attribute R who have achieved the goal G. Alternatively, the score assigned to a recommendation may be determined based on the frequency of the recommended attribute R among the set of members who have achieved the goal G, such as M(G, R)/M(G).

In some cases, the member may select a professional goal that only a small number of members (e.g., no members) of the social network service have achieved. In such cases, the recommendation module 220 may select a larger group of target members who have achieved career outcomes similar to the specified professional goal. For example, the recommendation module 220 may identify a group of members who have current positions that belong to a professional category that the member's professional goal also belongs. A professional category may be defined based on categorical attributes including, but not limited to, an occupational category (e.g. “Technology Manager”), a job function (e.g. “Engineering”), an industry (e.g. “Internet”), a location (e.g. “San Francisco Bay Area”), and combinations thereof. A professional category may also be defined by applying a title standardization algorithm to identify the common job title most similar to a specified job title. For example, two members with the respective job titles “Senior Hadoop Software Engineer” and “Sr. Java Engineer 2” could both be assigned the standard job title “Senior Software Engineer.”

In cases where a member selects a second member of the social network as an aspiration, the recommendation module 220 may extract categorical professional attributes from the second member's profile, and identify a group of target members with the same categorical attributes. In cases where a member selects a job opportunity as an aspiration, the recommendation module 220 may extract categorical professional attributes from the content of the job posting, and identify a group of target members with those categorical attributes.

In some cases, when comparing attributes associated with a group of members of the social network that have successfully completed a transition from a first work profession associated with a current profession of the member to a second profession associated with the professional goal, there may be few or no other members of the social network service that have made the exact same transition between the two work professions, as specified. For example, there may be no other members who previously held the same title at the same company where the given member is currently working. In such cases, the recommendation module 220 may select a larger group of target members who made a transition from a first work profession similar to the current profession of the member to a second profession similar to the professional goal.

In selecting a category of target members for comparison with the given member, the recommendation module 220 may select the most specific relevant category for which the social network service has enough data to identify significant statistical associations and determine useful recommendations, among other things.

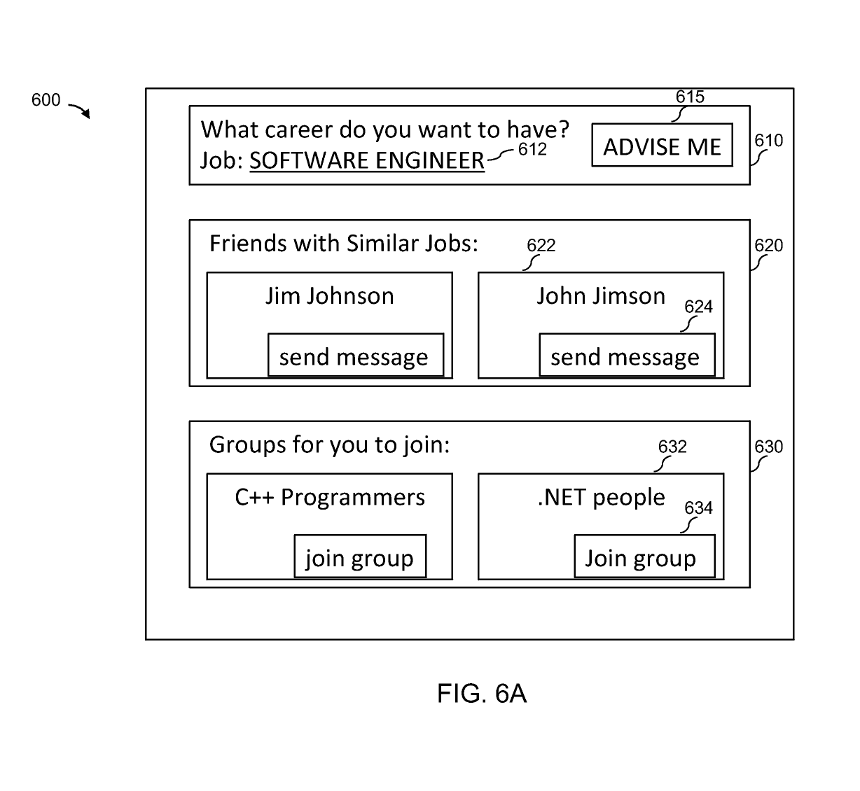

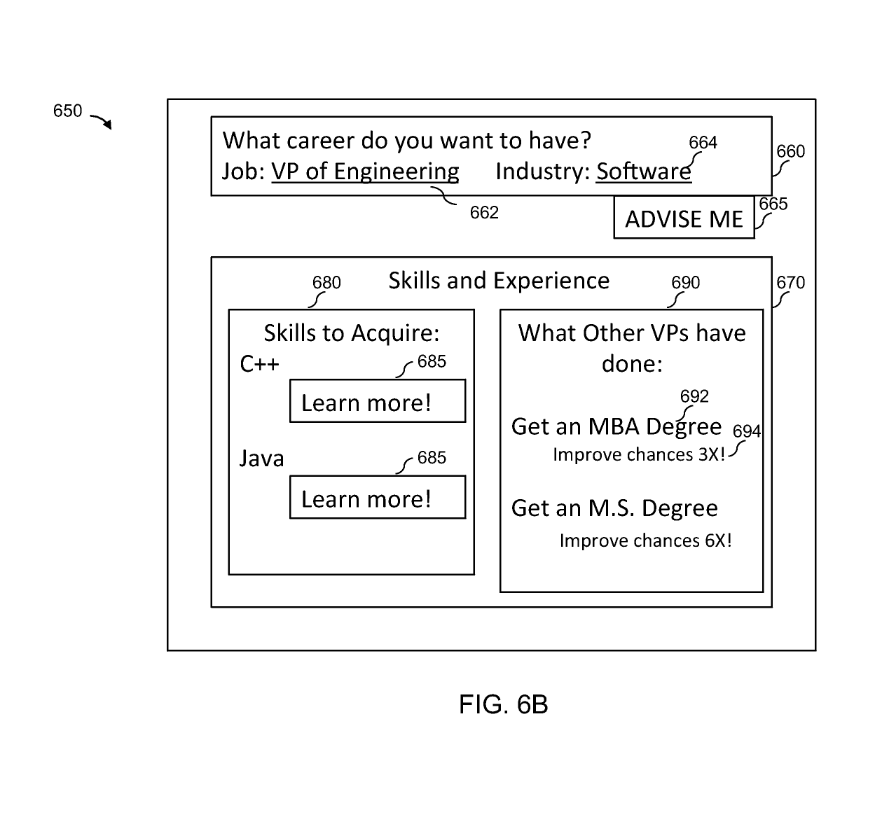

As described herein, in some example embodiments, the career recommendation engine 160 causes recommendations to be displayed to a member of a social network, such as via a user interface 145 associated with or displayed by the social network service 130. FIGS. 6A and 6B are display diagrams illustrating recommendations presented to a member of a social network, consistent with some embodiments.

FIG. 6A depicts a user interface 600 that includes an input component 610 configured to receive input from a member that is associated with a professional goal or aspiration, and an actionable graphical user interface element (e.g., a button) 615 that, when selected, causes the career recommendation engine 160 to perform methods to determine recommendations to present to the member based on a variety of information, including input information 612. For example, user interface 600 depicts that a member has provided input identifying a professional goal of becoming a “software engineer.”

The user interface 600 displays various recommendations, such as via a graphical element 620 displaying information for members or friends with similar jobs (e.g., members that have achieved the professional goal), and via a graphical element 630 displaying information for groups associated with the professional goal.

The graphical elements may also include links, actionable buttons, and/or other user-selectable elements that enable or facilitate a connection, association or affiliation between the member and the presented recommendations. For example, the graphical element 620 that displays information for other members associated with the professional goal, such as member 622, provides an actionable button 624 that, when selected, enables the member to send a message or otherwise connect with the member 622. As another example, the graphical element 630 that displays information for groups associated with the professional goal, such as group 632, provides an actionable button 634 that, when selected, enables the member to join the group 632.

FIG. 6B depicts a user interface 650 that includes an input component 660 configured to receive input from a member that is associated with a professional goal or aspiration, and an actionable button 665 that, when selected, causes the career recommendation engine 160 to perform methods to determine recommendations to present to the member based on a variety of information, including input information 662 and 664. For example, user interface 650 depicts a member has provided input identifying a job title of “VP of Engineering” in the “software” industry.

The user interface 650 displays various recommendations 670, such as a graphical element 680 displaying information identifying skills associated with the professional goal, and a graphical element 690 displaying information for achievements and/or experiences associated with members of the social network that have achieved the professional goal.

The graphical elements may also include links, actionable buttons, and/or other user-selectable elements that enable or facilitate a connection, association or affiliation between the member and the presented recommendations. For example, the graphical element 680 that displays information for skills to be acquired by the member provides an actionable button 685 that, when selected, enables the member to obtain more information associated with the skill (e.g., information identifying classes, websites, and so on). As another example, the graphical element 690 displays the specific achievements or experiences that should be obtained by the member, such as achievement 692, along with a metric, score, or other information 694 that identifies an importance or benefit for the member to obtain the achievement in order to reach the professional goal.

Although the user interfaces 600 and 650 present a variety of different recommendations, the career recommendation engine 160 may present other recommendations to a member not specifically depicted. Examples include:

A recommendation that includes information identifying another member of the social network that is associated with the professional goal, along with an actionable button that, when selected by the member, performs an action connecting the member to the other member;

A recommendation that includes information identifying another member or entity of the social network that is associated with the professional goal, along with an actionable button that, when selected by the member, performs an action enabling the member to follow the another member or entity;

A recommendation that includes information identifying a group of members within the social network that is associated with the professional goal, along with an actionable button that, when selected by the member, performs an action enabling the member to join the identified group of members;

A recommendation that includes information identifying news items presented within the social network that are associated with the professional goal, along with an actionable button that, when selected by the member, performs an action enabling the member to receive additional information about the identified news items;

A recommendation that includes information about another member of the social network that has achieved the professional goal or has performed an action to achieve the professional goal;

A recommendation that includes information identifying a skill that is useful in achieving the professional goal, along with an actionable user interface element that, when activated by the member, enables the member to perform an action to acquire the skill;

A recommendation that includes information identifying skills that are associated with the professional goal, along with an actionable button that, when selected by the member, performs an action that displays sponsored content associated with the identified skills;

A recommendation that includes information identifying educational experiences associated with the professional goal, along with an actionable button that, when selected by the member, performs an action that displays sponsored content associated with the educational experiences;

A recommendation that includes information identifying available job listings within the social network that are associated with the professional goal, along with an actionable button that, when selected by the member, performs an action that enables the member to apply to one or more jobs associated with the available jobs listings;

A recommendation that includes information identifying a geographic location or region associated with more opportunities to achieve the professional goal or aspiration, and so on.

In some example embodiments, a recommendation associated with a professional goal may be provided by another member of the social network service. The social network service may store this recommendation, show the recommendation to various members, and receive and store endorsements or other feedback about the recommendation from those members. The career recommendation engine 160 may provide the recommendation to the given member, depending on the social graph and the feedback on the recommendation from other members.

In some example embodiments, a recommendation may be provided to the member of the social network via a user interface displayed by the social network service. The user interface may be presented as part of any web page displayed by the social network service, including a profile page of the member, a profile page of a different member associated with the first member's professional goal, a page describing a job opportunity, a home page displayed after the member logs into the social network service, or a page on a standalone web site operated by the social networking service. In other embodiments, a recommendation may be provided via a mobile application operated by the social networking service, or via an electronic message generated or transmitted by the social networking service. In some embodiments, a recommendation determined based on information stored by a social network may be provided to a member of the social network by a third party using an application interface provided by the social network service.

In some example embodiments, the social network service may persistently store information describing a member's professional goal. For example, input associated with a professional goal that is received from a member, as well as structured data derived from this input, may be stored in the member database 172 of the social network service 130. This information could be used at a later time to determine a new recommendation relevant to the member's professional goal, based on new information received by the social network service 130. For example, if an employer posts a new job opportunity that is relevant to a professional goal previously specified by a member, the social network service 130 may provide the member with a new recommendation to apply for the new job opportunity. The member may be notified of the new recommendation via an updated web page displayed by the social network service 130, via an email message, and so on

In general, the social network service 130 may periodically execute algorithmic processes used to determine recommendations in response to goal information previously received from any member, using any information stored by the social network service 130 at the time. In some example embodiments, the social network service 130 may provide other personalized recommendations or content, such as a list of companies for the member to follow, a set of professional news articles for the member to read, and/or a stream of updates from other members of the social network service 130. Information about a member's professional goal may be used as an indication of the member's professional interests, in order to select personalized recommendations and content that is associated with the professional goal. Information about professional goals stored by the social network service may be used as an input by any existing recommendation and content systems, or by any new recommendation and content systems developed by the social network service 130 in the future, to optimize the relevance of recommendations and content provided to the member. Thus the social network service 130 may help members to take steps towards achieving their career aspirations, on an on-going basis and/or periodic basis. For example, the social network service 130 may facilitate storing input associated with a professional goal on a persistent storage medium at a first time, determining a new recommendation based on new information stored by the social network at a second time after the first time, and providing the recommendation to the member of the social network.

Thus, in some example embodiments, the career recommendation engine 160 provides data driven career advice that determines career recommendations based on goals provided by members and based on information stored by a social network, among other benefits.

### Example Scenarios

The following scenarios present examples of the career recommendation engine 160 presenting recommendations in response to received and/or accessed professional goal information.

Scenario 1—The Student

A student accesses her professional social network, and inputs a goal of becoming a middle school teacher. The social network, via a supported career recommendation engine 160, aggregates the attribute information for a group of members that are middle school teachers, and selects attributes the members have in common (e.g., a degree in education, teaching experience). The career recommendation engine 160 presents a recommendation to the student to obtain a degree in education, along with links to online and local programs that provide courses associated with the recommended education degree.

Scenario 2—The Career Change

A professional in information technology wishes to change careers and move into management. The professional selects three members of the social network that have positions the professional would like to realize. The career recommendation engine 160 aggregates the attribute information for the group of members, and determines a career path based on the collective attributes of the group that includes getting a Professional Master's Degree and obtaining new skills, and presents the recommendation to the professional along with a link to universities in the professional's location that provide such degrees.

Of course, other scenarios not described herein may be realized by the systems and methods described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

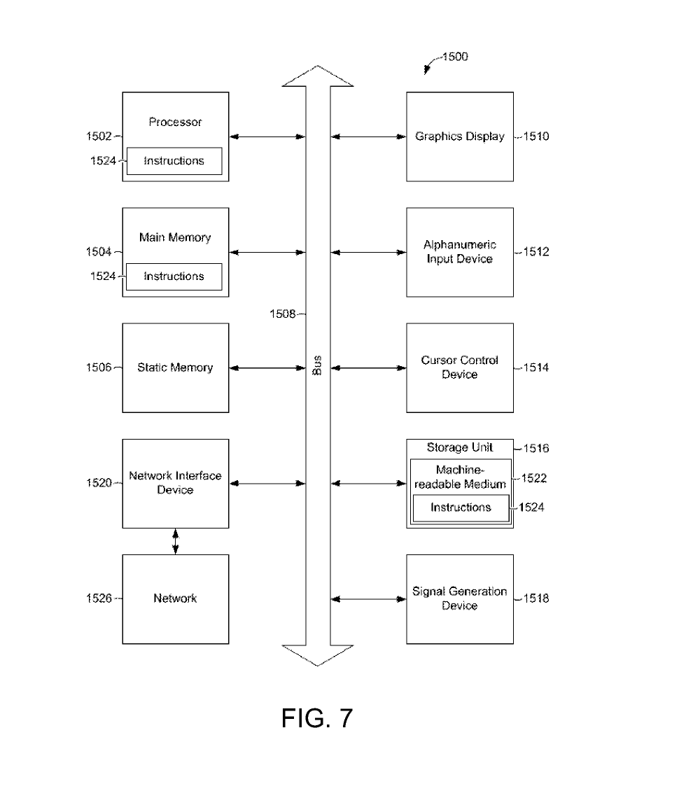

FIG. 7 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a display unit 1510, an alphanumeric input device 1512 (e.g., a keyboard), and a user interface (UI) navigation device 1514 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors, such as a global positioning system sensor, compass, accelerometer, or other sensor.

The drive unit 1516 includes a machine-readable medium 1522 on which is stored one or more sets of instructions and data structures (e.g., software 1524) embodying or utilized by any one or more of the methodologies or functions described herein. The software 1524 may also reside, completely or at least partially, within the main memory 1504 and/or within the processor 1502 during execution thereof by the computer system 1500, the main memory 1504 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1524 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although some embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
receiving input associated with a professional goal from a member of a social network;
determining a recommendation based on information stored by the social network; and
providing the recommendation to the member of the social network.

2. The method of claim 1, wherein determining a recommendation based on information stored by the social network includes determining a recommendation based on a comparison of attributes associated with the member of the social network to attributes associated with the professional goal.

3. The method of claim 1, wherein determining a recommendation based on information stored by the social network includes determining a recommendation based on a comparison of attributes associated with the member of the social network to attributes associated with another member of the social network that has achieved the professional goal.

4. The method of claim 1, wherein determining a recommendation based on information stored by the social network includes determining a recommendation based on attributes associated with the professional goal.

5. The method of claim 1, wherein determining a recommendation based on information stored by the social network includes determining a recommendation based on attributes associated with another member of the social network that has achieved the professional goal.

6. The method of claim 1, wherein determining a recommendation based on information stored by the social network includes determining a recommendation based on attributes associated with a group of members of the social network that have achieved the professional goal.

7. The method of claim 1, wherein determining a recommendation based on information stored by the social network includes determining a recommendation based on attributes associated with a group of members of the social network that have successfully completed a transition from a first work profession associated with a current profession of the member to a second profession associated with the professional goal.

8. The method of claim 1, wherein determining a recommendation based on information stored by the social network includes automatically identifying actions taken by other members of the social network that are statistically associated with achieving the professional goal input by the member of the social network.

9. The method of claim 1, wherein determining a recommendation based on information stored by the social network includes automatically identifying attributes of other members of the social network that are statistically associated with achieving the professional goal input by the member of the social network.

10. The method of claim 1, wherein determining a recommendation based on information stored by the social network includes identifying actions recommended by other members of the social network.

11. The method of claim 1, wherein receiving input associated with a professional goal from a member of a social network includes receiving information associated with an aspirational job title from the member of the social network.

12. The method of claim 1, wherein receiving input associated with a professional goal from a member of a social network includes receiving information associated with an occupation and an industry from the member of the social network.

13. The method of claim 1, wherein receiving input associated with a professional goal from a member of a social network includes receiving information associated with a company from the member of the social network.

14. The method of claim 1, wherein receiving input associated with a professional goal from a member of a social network includes receiving information associated with a geographic location from the member of the social network.

15. The method of claim 1, wherein receiving input associated with a professional goal from a member of a social network includes receiving information associated with a published job opportunity from the member of the social network, the job opportunity representing the professional goal of the member.

16. The method of claim 1, wherein receiving input associated with a professional goal from a member of a social network includes receiving information associated with a second member of the social network, the second member selected by the first member as an example of a person who has achieved the input professional goal.

17. The method of claim 1, wherein providing the recommendation to the member of the social network includes providing information identifying a recommended career path for the member of the social network.

18. The method of claim 1, wherein providing the recommendation to the member of the social network includes providing information associated with a recommended work experience for the member of the social network.

19. The method of claim 1, wherein providing the recommendation to the member of the social network includes providing information associated with a recommended educational experience for the member of the social network.

20. The method of claim 1, wherein providing the recommendation to the member of the social network includes providing information associated with recommended skills training for the member of the social network.

21. The method of claim 1, wherein providing the recommendation to the member of the social network includes providing information associated with a recommended work experience along with information identifying one or more job listings contained by the social network and associated with the recommended work experience.

22. The method of claim 1, wherein providing the recommendation to the member of the social network includes:
at a first time and in response to the received input, storing the input associated with a professional goal on a persistent storage medium;
at a second time later than the first time, determining a new recommendation based on new information stored by the social network at the second time; and
providing the recommendation to the member of the social network.

23. A system, comprising:
a goal reception module that is configured to receive input associated with a professional goal from a member of a social network;
a recommendation module that is configured to determine a recommendation based on comparing attributes of the member to attributes of other members of the social network; and
a presentation module that is configured to present the recommendation to the member of the social network.

24. A computer-readable storage medium whose contents, when executed by a computing system, cause the computing system to perform operations, comprising:
receiving input that identifies a job title from a member of a social network;
identifying other members within the social network that have the identified job title;
comparing attributes of the member to attributes of the other members within the social network that have the identified job title;
determining at least one difference between the attributes of the member and the attributes of the identified other members; and
providing a recommendation to the member of the social network based on the determined difference.
